(19) United States
(12) Patent Application Publication
(10) Pub. No.: US 2018/0051492 A1
(43) Pub. Date: Feb. 22, 2018

(54) HANDLE CHASSIS WITH MULTI-HEIGHT MOUNTING BOSS FOR VEHICLE DOOR ASSEMBLY

(71) Applicant: GM GLOBAL TECHNOLOGY OPERATIONS LLC, Detroit, MI (US)

(72) Inventor: Eric J. Smith, Clarkston, MI (US)

(73) Assignee: GM GLOBAL TECHNOLOGY OPERATIONS LLC, Detroit, MI (US)

(21) Appl. No.: 15/239,312

(22) Filed: Aug. 17, 2016

(51) Int. Cl. E05B 79/06; B60J 5/04; E05B 85/16

(52) U.S. Cl. CPC E05B 79/06; E05B 85/16; B60J 5/04

(57) ABSTRACT

Disclosed are vehicle door handle chassis, methods for making such chassis, and vehicle door assemblies with handle chassis. An example is a handle chassis for a motor vehicle door assembly. The door assembly includes a door panel, which has either a thin or a thick door panel construction. The handle chassis includes a chassis frame that secures to the door panel. The chassis frame has handle apertures for securing the door handle to the chassis. A mounting boss, which projects from the chassis frame, includes a distal end with a stepped region having high and low end faces each with a distinct height. The high end face presses against the inboard surface of a door panel having the thin construction. For a door panel having the thick construction, the low end face presses against the inboard surface while the first end face seats inside a hole in this door panel.

### TECHNICAL FIELD

The present disclosure relates generally to door assemblies for motor vehicles. More specifically, aspects of this disclosure relate to door handle mechanisms for manually operating a motor vehicle door assembly.

### BACKGROUND

Many current production motor vehicles, such as the modern-day automobile, are originally equipped with driver-side and passenger-side door assemblies that are movably mounted to the vehicle body to provide access for entering and exiting the vehicle. Conventional vehicle door assemblies are customarily designed with an armrest that extends from the interior of the door assembly into the passenger compartment. The armrest is intended, in part, to provide a surface on which an occupant seated adjacent the door may rest the lower extremities of his or her arm. Typically part of a decorative trim structure defining the inner surface of the door assembly, the armrest is often integrated with a door latch release lever and a pull-handle or pull-cup used to open and close the door assembly. The majority of conventional armrest assemblies are self-contained units that are positively attached to the door's inner support panel or other structural components of the vehicle by, for example, screws, bolts, push pins, or heat stakes.

A vehicle door handle is also provided along the exterior of the door's outer panel and employed to pull the vehicle door assembly from a closed position to an open position, so that the occupant can enter the vehicle, and vice-versa after the occupant alights from the vehicle. Exterior door handles typically function in cooperation with, or operate as, a door latch release lever to selectively disengage the door latch such that the vehicle door assembly, in turn, can be opened. A conventional exterior door handle includes a handle portion that is pivotable relative to a mounting chassis secured to the inside surface of the door's outer panel. Pivotal movement of the handle portion applies tension to a cable that moves a latch mechanism to release the door latch and open the door. Locking mechanisms can also be provided to prevent the various vehicle door assemblies from unwantedly opening during or after operation of the vehicle.

### SUMMARY

Disclosed herein are handle chassis for vehicle door assemblies, methods for making and methods for using such chassis, and motor vehicles with a door assembly using a handle chassis to mount an exterior door handle. By way of non-limiting example, an improved door handle chassis is presented that includes an elongated rigid frame with mounting interfaces, such as fastener slots and/or mounting hooks, for securing the handle chassis to the inboard surface of a vehicle door's outer panel. Handle apertures in the chassis frame receive attachment arms of an exterior door handle to mount the handle to the outboard surface of the door's outer panel. The frame can be fabricated with numerous cable attachment ports for mating with cable clips that secure a latch release cable to the chassis frame. In the same vein, coupling structure can be incorporated into the chassis frame for mounting thereto a counter balance, an inertia lock, and other optional components for the exterior door handle and locking mechanism.

Integrally formed with or otherwise attached to the chassis frame are multiple mounting bosses that project generally orthogonally from an outboard surface of the frame. A distal end of each mounting boss, opposite that of the end formed with or attached to the chassis frame, has a stepped region with step segments of different heights to accommodate mounting the chassis to door outer panels of varying thicknesses. For a thin outer panel construction, the end face of the step segment with the largest height will press against the inboard surface of the panel to ensure proper spacing and orientation. A thick outer panel construction, on the other hand, will be fabricated with complementary holes at the locations of the mounting bosses; these holes are designed to receive therein the step segment with the largest height such that the end face of a stepped segment with a lower height presses against the inboard surface of the panel. These mounting features allow the handle chassis to mount securely to panels of various thicknesses, such as a thick panel (e.g., 0.75-0.95 mm thick) stamped from aluminum and a thin panel (e.g., 0.5-0.7 mm thick) stamped from steel. This concept can be adapted for additional panel thickness, e.g., by providing additional mounting boss heights in the bracket and/or more or larger holes in the outer panels.

Attendant benefits for at least some of the disclosed concepts include reducing part costs and design and proof-of-concept costs for exterior door handle chassis by designing a single universal chassis that can be employed across multiple vehicle platforms. Warranty and assembly issues are also reduced by eliminating the possibility of an incorrect door handle chassis being installed on a vehicle. Other benefits may include minimizing tooling investment required for multiple part designs, as well as reducing logistics complexity associated with different part numbers required for multiple door handle chassis configurations. Also, efficiency losses associated with downtime for multiple tool set-ups are eliminated. Disclosed designs also eliminate the need to install error-proofing devices to ensure that very similar chassis are not inadvertently comingled or mislabeled.

Aspects of the present disclosure are directed to exterior door handle chassis for vehicle door assemblies. Disclosed, for example, is a handle chassis for a door assembly of a motor vehicle. The door assembly includes a door handle and a door panel, which has either a first (thin) door panel construction with a first thickness or a second (thick) door panel construction with a second thickness that is greater than the first thickness. The handle chassis includes a chassis frame with one or more mounting interfaces that secure the handle chassis to the inboard surface of the door panel. The chassis frame also has one or more handle apertures that receive complementary portions of the door handle and thereby secure the door handle to the handle chassis and, thus, to the door panel. One or more mounting bosses are attached to and project from an outboard surface of the chassis frame. Each mounting boss includes a distal end with a stepped region having a first end face with a first height relative to the frame, and a second end face with a second height relative to the frame. The second height is less than the first height. The first end face of the stepped region presses against the inboard surface of a door panel having the first (thin) door panel construction. Conversely, for a door panel having the second (thick) door panel construction, the second end face presses against the inboard surface of the door panel while the first end face seats inside a recess or hole in the door panel.

Other aspects of the present disclosure are directed to motor vehicles with driver-side and passenger-side door assemblies. A “motor vehicle,” as used herein, may include any relevant vehicle platform, such as passenger vehicles (internal combustion engine (ICE), hybrid, electric, fuel cell, etc.), commercial vehicles, industrial vehicles, tracked vehicles, all-terrain vehicles (ATV), farm equipment, boats, airplanes, spacecraft, etc. In an example, a motor vehicle is disclosed that includes a vehicle body with a door frame, and a door assembly with a door support panel movably mounted to the door frame. The door panel, which includes a pair of handle through-holes, has either a first (thin) door panel construction with a first thickness or a second (thick) door panel construction with a second thickness that is greater than the first thickness. The door assembly also includes an exterior door handle with a pair of attachment arms, each of which extends through a respective one of the handle through-holes in the door panel.

The vehicle door assembly also includes a handle chassis for securely mounting the door handle to the door panel. The handle chassis if composed of a chassis frame with a mounting interface—a fastener slot and a mounting hook—for securing the handle chassis to the inboard surface of the door panel. The chassis frame has a pair of handle apertures, each of which receives a respective one of the attachment arms and thereby secures the door handle to the handle chassis and, thus, to the door outer panel. The handle chassis also includes multiple mounting bosses that are integrally formed with and project from an outboard surface of the chassis frame. Each mounting boss includes a distal end with a stepped region having a first end face with a first height and a second end face with a second height relative to the frame. If the door panel has the first door panel construction, the first end faces of the mounting bosses press against the inboard surface of the door panel while the second end faces are spaced from the inboard surface. In contrast, if the door panel has the second door panel construction, the second end faces of the mounting bosses press against the inboard surface of the door panel while the first end faces seat inside chassis recesses or holes in the door panel.

In yet other aspects of the present disclosure, methods of making and methods of using exterior door handle chassis for vehicle door assemblies are presented. For instance, a method is presented for constructing a handle chassis for a door assembly of a motor vehicle. The door assembly includes a door handle and a door panel, which has either a first (thin) door panel construction with a first (smaller) thickness or a second (thick) door panel construction with a second (larger) thickness. The method includes, in any order and in any combination: forming a chassis frame with a mounting interface configured to secure the handle chassis to an inboard surface of the door panel, the chassis frame being formed with a handle aperture configured to receive a portion of the door handle and thereby secure the door handle to the handle chassis; and, forming a mounting boss to project from the chassis frame, the mounting boss being formed with a distal end with a stepped region having a first end face with a first height and a second end face with a second height less than the first height. The first end face of the stepped region is configured to press against the inboard surface of a door panel having the first door panel construction. The second end face is configured to press against the inboard surface of the door panel having the second door panel construction while the first end face is configured to seat inside a hole in the door panel having this construction. These forming steps may include integrally forming the chassis frame and the mounting boss as a single-piece, unitary structure. It is also possible to two-shot mold the frame and mounting boss. Alternatively, these pieces can be formed separately and subsequently joined together by any suitable joining technique. As another option, the method may include forming a plurality of the mounting bosses to project from an outboard surface of the chassis frame. This may comprise first and second mounting bosses spaced on opposing sides of the handle aperture.

The above summary is not intended to represent every embodiment or every aspect of the present disclosure. Rather, the foregoing summary merely provides an exemplification of some of the novel aspects and features set forth herein. The above features and advantages, and other features and advantages of the present disclosure, will be readily apparent from the following detailed description of representative embodiments and modes for carrying out the present disclosure when taken in connection with the accompanying drawings and the appended claims.

### BRIEF DESCRIPTION OF THE DRAWINGS

FIG. 1 is an elevated perspective-view illustration of a representative motor vehicle with a partially exploded inset view of a representative vehicle door assembly in accordance with aspects of the present disclosure.

FIGS. 2A and 2B are enlarged perspective-view illustrations of select portions of the vehicle door assembly of FIG. 1 showing a representative door handle chassis mounted to a door outer panel.

FIG. 3 is a cross-sectional side-view illustration of a representative multi-height mounting boss interfacing with a door outer panel having a first (thin) door panel construction.

FIG. 4 is a cross-sectional side-view illustration of the multi-height mounting boss of FIG. 3 interfacing with a door outer panel having a second (thick) door panel construction.

The present disclosure is susceptible to various modifications and alternative forms, and some representative embodiments have been shown by way of example in the drawings and will be described in detail herein. It should be understood, however, that the novel aspects of this disclosure are not limited to the particular forms disclosed in the drawings. Rather, the disclosure is to cover all modifications, equivalents, combinations, subcombinations, and alternatives falling within the spirit and scope of the disclosure as defined by the appended claims.

### DETAILED DESCRIPTION OF THE ILLUSTRATED EMBODIMENTS

This disclosure is susceptible of embodiment in many different forms. There are shown in the drawings and will herein be described in detail representative embodiments of the disclosure with the understanding that the present disclosure is to be considered as an exemplification of the principles of the disclosure and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference or otherwise. For purposes of the present detailed description, unless specifically disclaimed: the singular includes the plural and vice versa; the words “and” and “or” shall be both conjunctive and disjunctive; the word “all” means “any and all”; the word “any” means “any and all”; and the words “including” and “comprising” and “having” mean “including without limitation.” Moreover, words of approximation, such as “about,” “almost,” “substantially,” “approximately,” and the like, can be used herein in the sense of “at, near, or nearly at,” or “within 3-5% of,” or “within acceptable manufacturing tolerances,” or any logical combination thereof, for example.

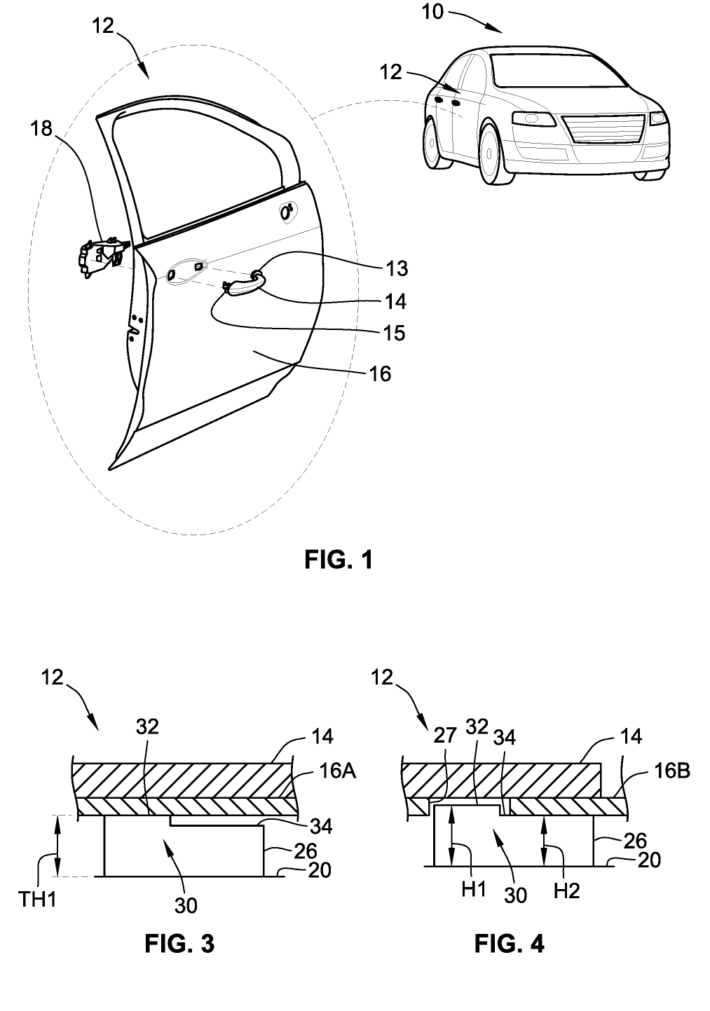

Referring now to the drawings, wherein like reference numbers refer to like features throughout the several views, there is shown in FIG. 1 a perspective-view illustration of a representative automobile, which is designated generally at 10 and portrayed herein for purposes of discussion as a sedan-style passenger car. Mounted at a lateral portion of the automobile 10, e.g., hinged to a door frame defined, in part, by juxtaposed support pillars of the vehicle body, is a representative vehicle door assembly 12. As described in extensive detail below, the door assembly 12 is provided with an exterior door handle 14 that is operatively mounted to an outer door panel 16 via a handle chassis 18. The automobile 10—also referred to herein as “motor vehicle” or “vehicle” for short—is merely an exemplary application with which the novel aspects of this disclosure can be practiced. In the same vein, the implementation of the present concepts into an exterior door handle of a passenger-side door assembly should also be appreciated as an exemplary application of the novel concepts disclosed herein. As such, it should be understood that the novel aspects and features of the present disclosure can be integrated into other door assemblies for different door handles and utilized for any logically relevant type of motor vehicle. Lastly, the drawings presented herein, are not necessarily to scale and are provided purely for instructional purposes. Thus, the specific and relative dimensions shown in the drawings are not to be construed as limiting.

Vehicle door assembly 12 of FIG. 1 can be pivotably mounted, e.g., via a multi-stage check-spring door hinge, to the vehicle body's door frame to provide access to and securely close a portion of the passenger compartment. The door assembly 12 has a door latch system (not shown) for securing the door assembly 12 to the door frame in a closed position. By way of example, the exterior door handle 14 is pulled, pivoted or otherwise moved, e.g., away from the door panel 16, to apply a tensile force to an internal cable of the door latch system and thereby activate a spring-biased latch. This allows the door assembly 12 to be moved to an open position. Upon release of the door handle 14, the internal cable, which may be of the Bowden cable type, will be biased back to its original position by the spring-biased latch such that the latch mechanism can reengage a complementary latch plate on the door frame when the vehicle door assembly 12 is moved back to the closed position. An optional locking mechanism (not shown in the drawings) may be provided to prevent unwanted activation of the door latch system.

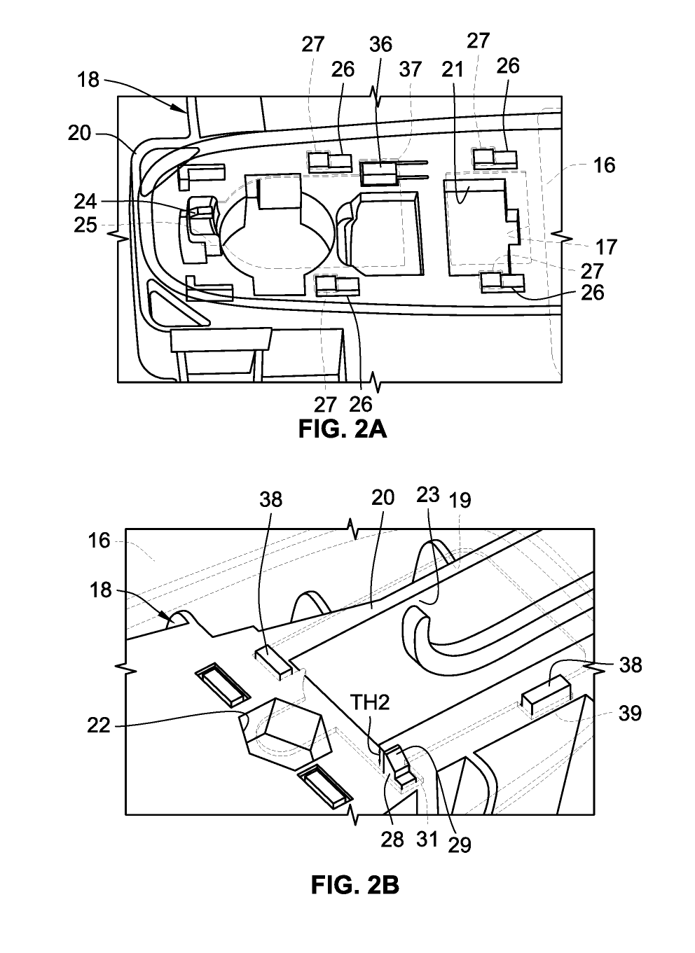

Referring next to FIGS. 2A and 2B, there is shown mounted along an inboard-facing (inside) surface of the door panel 16 a handle chassis 18 that provides subjacent support for operation of the door handle 14. The handle chassis 18, which may be fabricated from a molded plastic or other suitable material, is composed of an elongated rigid frame 20 that is positioned to align first and second handle apertures 21 and 23 in the handle chassis 18 with corresponding handle holes 17 and 19 that extend through the door panel 16. While any of an assortment of sizes, orientations, and geometries are envisioned, the handle through-holes 17, 19 and handle apertures 21, 23 each has a generally polygonal shape sized to circumscribe a portion of the door handle 14. A coupling arm 13 and a pivot arm 15 extend inboard from opposing sides of handle 14; these arms travel through the handle through-holes 17 and 19 and into the handle apertures 21, 23 to secure the handle for pivoting movement with respect to both the door panel 16 and handle chassis 18. The door handle 14 pivots about the pivot arm portion 15 to operate the door latch system described above.

Many of the moving components of an exterior door handle mechanism can be attached directly to the rigid chassis frame 20, such as assorted cable retainers, pulleys, a bell crank, a counter balance, an inertia lock, etc. These components are not necessary to form an understanding of the novel features of the present disclosure and therefore will not be described in detail herein. Chassis frame 20 has a mounting interface for securely coupling the handle chassis 18 and any components mounted thereon to the inboard surface of the door panel 16. In accord with the illustrated example, the mounting interface comprises a fastener slot 22 located proximal a front end of the frame 20. A threaded fastener, such as a pan-head star-drive screw, passes through the door outer panel 16 and threadably mates with a screw anchor in the fastener slot 22 for rigidly securing the handle chassis 18 to the door panel 16. Proximal a rear end of the frame 20 is a mounting hook 24 that passes through and wraps around a chassis slot 25 in the door panel 16. A worm-screw clamp (not shown) then sandwiches a door inner (fascia) panel between the handle 14 and chassis 18.

To assist with locating and properly seating the handle chassis 18 against the door outer panel 16 during fabrication of the vehicle door assembly 12, one or more mounting bosses 26 and 28 are provided that project from the chassis frame 20 and interface with the panel 16. It may be desirable, for ease of manufacture, to integrally form, e.g., via blow molding, injection molding, hydroforming, etc., all of the mounting bosses 26, 28 with the chassis frame 20 to construct a single-piece, unitary structure. As shown, each mounting boss 26, 28 projects generally orthogonally from an outboard surface of the chassis frame 20 to interpose between the handle chassis 18 and outer panel 16. All of the mounting bosses 26, 28 are portrayed with a polyhedral shape, e.g., with seven or more sides. One set of the (first) mounting bosses 26 are arrayed with mounting bosses spaced on opposing sides of a handle aperture 21, extending longitudinally with respect to the frame 20, as seen in FIG. 2A. Alternative positions and orientations, such as a transverse orientation positioned at the longitudinal end of a handle aperture 23 (FIG. 2B), are also within the scope of this disclosure. Optional configurations may include forming one or more or all of the mounting bosses as separate pieces, and subsequently attaching the boss(es) to the frame, e.g., via sonic welding, adhesives, etc. As another optional alternative, any one of the bosses can be fashioned to project from a fore, aft, top or bottom surface of the frame at any of an assortment of angles depending, for example, on the frame layout and the contours of the door panel's inboard surface. It is also envisioned that the bosses take on any combination of shapes, sizes and geometries.

Mounting bosses 26 and 28 can be substantially similar in shape and size or, conversely, can each be disparately designed to incorporate dissimilar features. By way of non-limiting example, all four mounting bosses 26 in the set of first mounting bosses shown in FIG. 2A are substantially identical. Comparatively, the second type of mounting boss 28 shown in FIG. 2B is distinctly shaped and sized from the other mounting bosses. As seen in FIG. 3, for instance, the first type of mounting boss 26 has a first total height TH1, whereas the second type of mounting boss 28 has a second total height TH2 that is larger than the first total height TH1. Another point of demarcation is that the distal tip of the first mounting boss 26 is substantially flat and generally parallel to the outboard surface of the chassis frame 20. Contrastingly, the distal tip of the second mounting boss 28 includes a ramped lateral surface 29 that is configured to engage the inner periphery of a complementary boss hole 31 in the door panel 16 and thereby align the handle chassis 18 with the panel 16 during attachment to the door assembly 12. It is also envisioned that the distal tips of each mounting boss take on rounded forms and/or include a flexible material.

All of the mounting bosses 26 and 28 are tiered, multi-height structures that cooperatively allow the handle chassis 18 to mount securely to support panels of various thicknesses, such as a “thick” panel (e.g., 0.75-0.95 mm thick) stamped from aluminum and a “thin” panel (e.g., 0.5-0.7 mm thick) stamped from steel. Using first mounting boss 26 as a representative example, a distal end of the boss 26—the end opposite that of a proximal end formed with or attached to the chassis frame 20—terminates at a stepped region 30 having a first end face 32 with a first height H1 and a second end face 34 with a second height H2 that is less than the first height H1. For door assembly configurations employing an outer door panel 16A having a “thin” door panel construction, as seen in FIG. 3, the first end face 32 of the stepped region 30 presses against the inboard surface of door panel 16A. At the same time, the second end face 34 of the mounting boss 26 is spaced inwardly from the inboard surface of the door panel 16A. However, if the door assembly 12 employs an outer door panel 16B having a “thick” door panel construction, as seen in FIG. 4, the second end face 34 will press against the inboard surface of the door panel 16B, while the first end face 32 seats inside a boss hole 27 formed in or through the door panel 16B.

For at least some embodiments, the stepped region 30 of the mounting boss 26 can be fabricated with one or more additional end faces, each having a distinct height. For instance, a third end face with a third height that is less than the second height of the second end face will press against the inboard surface of a door panel having a third door panel construction with a third thickness that is greater than the second thickness, while the second end face seat insides a boss hole in the door panel having the third door panel construction. The handle chassis 18 can also be provided with one or more optional datum posts 36 (FIG. 2A) and 38 (FIG. 2B) that project, e.g., generally orthogonally from the outboard surface of the chassis frame 20. Each said datum post is designed to seat inside a complementary datum hole 37 and 39 in the door panel and thereby properly orient the handle chassis 18 during attachment to the door assembly 12.

While aspects of the present disclosure have been described in detail with reference to the illustrated embodiments, those skilled in the art will recognize that many changes may be made thereto without departing from the scope of the present disclosure. The present disclosure is not limited to the precise construction and compositions disclosed herein; any and all modifications, changes, and variations apparent from the foregoing descriptions are within the spirit and scope of the disclosure as defined in the appended claims. Moreover, the present concepts expressly include any and all combinations and subcombinations of the preceding elements and features.

What is claimed:

1. A handle chassis for a door assembly of a motor vehicle, the door assembly including a door handle and a door panel, the door panel having either a first door panel construction with a first thickness or a second door panel construction with a second thickness, the second thickness being greater than the first thickness, the handle chassis comprising:
a chassis frame with a mounting interface configured to secure the handle chassis to an inboard surface of the door panel, the chassis frame defining a handle aperture configured to receive a portion of the door handle and thereby secure the door handle to the handle chassis; and
a mounting boss attached to and projecting from the chassis frame, the mounting boss including a distal end with a stepped region having a first end face with a first height and a second end face with a second height less than the first height,
wherein the first end face of the stepped region is configured to press against the inboard surface of the door panel having the first door panel construction, and
wherein the second end face is configured to press against the inboard surface of the door panel having the second door panel construction while the first end face is configured to seat inside a hole in the door panel having the second door panel construction.

2. The handle chassis of claim 1, wherein the mounting boss includes a plurality of mounting bosses projecting from an outboard surface of the chassis frame.

3. The handle chassis of claim 2, wherein the mounting bosses include a first mounting boss having a first total height and a second mounting boss having a second total height distinct from the first total height.

4. The handle chassis of claim 2, wherein the mounting bosses include first and second substantially identical mounting bosses.

5. The handle chassis of claim 2, wherein the mounting bosses include first and second mounting bosses spaced on opposing sides of the handle aperture.

6. The handle chassis of claim 1, wherein the mounting boss projects generally orthogonally from an outboard surface of the chassis frame.

7. The handle chassis of claim 1, wherein the stepped region of the mounting boss includes a third end face with a third height less than the second height, the third end face being configured to press against the inboard surface of the door panel having a third door panel construction with a third thickness greater than the second thickness, and the second end face being configured to seat inside a hole in the door panel having the third door panel construction.

8. The handle chassis of claim 1, wherein the mounting boss is integrally formed with the chassis frame as a single-piece structure.

9. The handle chassis of claim 1, wherein the mounting boss has a polyhedral shape.

10. The handle chassis of claim 1, further comprising a datum post projecting from an outboard surface of the chassis frame, the datum post being configured to seat inside a datum hole in the door panel and thereby properly orient the handle chassis during attachment to the door assembly.

11. The handle chassis of claim 1, wherein the first end face includes a ramped lateral surface configured to engage an inner periphery of the hole in the door panel and thereby align the handle chassis during attachment to the door assembly.

12. The handle chassis of claim 1, wherein the mounting interface includes a fastener slot configured to receive therein a fastener for securing the chassis frame to the door panel.

13. The handle chassis of claim 1, wherein the mounting interface includes a mounting hook configured to pass through and wrap around a chassis slot in the door panel and thereby attach the chassis frame to the door panel.

14. A motor vehicle, comprising:
a vehicle body having a door frame; and
a door assembly, including:
a door panel movably mounted to the door frame and including a pair of handle through-holes, the door panel having either a first door panel construction with a first thickness or a second door panel construction with a second thickness, the second thickness being greater than the first thickness;
a door handle with a pair of attachment arms each extending through a respective one of the handle through-holes in the door panel; and
a handle chassis comprising a chassis frame with a fastener interface securing the handle chassis to an inboard surface of the door panel, the chassis frame defining a pair of handle apertures each receiving a respective one of the attachment arms and thereby securing the door handle to the handle chassis, a plurality of mounting bosses integrally formed with and projecting from an outboard surface of the chassis frame, each of the mounting bosses including a distal end with a stepped region having a first end face with a first height and a second end face with a second height less than the first height,
wherein the first end faces of the mounting bosses press against the inboard surface of the door panel having the first door panel construction while the second end faces are spaced from the inboard surface of the door panel having the first door panel construction, and
wherein the second end faces of the mounting bosses press against the inboard surface of the door panel having the second door panel construction while the first end faces seat inside chassis holes in the door panel having the second door panel construction.

15. A method of constructing a handle chassis for a door assembly of a motor vehicle, the door assembly including a door handle and a door panel, the door panel having either a first door panel construction with a first thickness or a second door panel construction with a second thickness, the second thickness being greater than the first thickness, the method comprising:
forming a chassis frame with a mounting interface configured to secure the handle chassis to an inboard surface of the door panel, the chassis frame being formed with a handle aperture configured to receive a portion of the door handle and thereby secure the door handle to the handle chassis; and
forming a mounting boss to project from the chassis frame, the mounting boss being formed with a distal end with a stepped region having a first end face with a first height and a second end face with a second height less than the first height,
wherein the first end face of the stepped region is configured to press against the inboard surface of the door panel having the first door panel construction, and
wherein the second end face is configured to press against the inboard surface of the door panel having the second door panel construction while the first end face is configured to seat inside a hole in the door panel having the second door panel construction.

16. The method of claim 15, wherein the forming the mounting boss includes forming a plurality of the mounting bosses to project from an outboard surface of the chassis frame.

17. The method of claim 16, wherein the mounting bosses include a first mounting boss having a first total height and a second mounting boss having s a second total height distinct from the first total height.

18. The method of claim 16, wherein the mounting bosses include first and second mounting bosses spaced on opposing sides of the handle aperture.

19. The method of claim 15, wherein the mounting boss projects generally orthogonally from an outboard surface of the chassis frame.

20. The method of claim 15, wherein the forming steps include integrally forming the chassis frame and the mounting boss as a single-piece, unitary structure.
